(19) United States
(12) Patent Application Publication
(10) Pub. No.: US 2012/0207454 A1
(43) Pub. Date: Aug. 16, 2012

(54) STREAMING SERVICE AND PLAYBACK DEVICE USING SVC SERVER

(75) Inventor: Kwang Yong KIM, Daejeon (KR)

(73) Assignee: Electronics and Telecommunications Research Institute, Daejeon (KR)

(21) Appl. No.: 13/397,164

(22) Filed: Feb. 15, 2012

(30) Foreign Application Priority Data
Feb. 16, 2011 (KR) 10-2011-0013663

(51) Int. Cl. H04N 5/93; G06F 15/16; H04W 84/02; H04N 7/26

(52) U.S. Cl. 386/353; 375/240.02; 709/231; 375/E07.026; 386/E05.001

(57) ABSTRACT

Disclosed are a streaming service and a playback device using a scalable video coding (SVC) server that provides a 3-screen or n-screen service using an SVC technology. Here, n may be a number greater than 3. A streaming service and terminal playing system using an SVC server may provide a single video content by constructing a single bit stream to have various spatial resolutions and qualities such as a high-definition (HD) level, a standard definition (SD) level, an H.264 level, and the like, and various frame-rates, thereby receiving a bit stream in a receiving terminal, and restoring and playing the bit stream so as to provide an optimal service to a terminal in various network environments and having various characteristics.

### CROSS-REFERENCE TO RELATED APPLICATION

This application claims the benefit of Korean Patent Application No. 10-2011-0013663, filed on Feb. 16, 2011, in the Korean Intellectual Property Office, the disclosure of which is incorporated herein by reference.

### BACKGROUND

1. Field of the Invention

The present invention relates to a streaming service and a playback device using a scalable video coding (SVC) server that provides a 3-screen or n-screen service using an SVC technology. Here, n may be a number greater than 3.

2. Description of the Related Art

A scalable video coding (SVC) technology may correspond to a global standard video compression (or coding) technology that may provide a single video content by constructing a single bit stream to have various spatial resolutions and qualities, and various frame-rates, thereby receiving a bit stream conforming to a receiving terminal environment, and restoring and playing the single bit stream so as to provide an optimal service in various network environments and various terminals when providing intelligent broadcasting content in a broadcasting and communication convergence situation.

### SUMMARY

An aspect of the present invention provides a streaming service and a playback device using a scalable video coding (SVC) server that may provide a single video content by constructing a single bit stream to have various spatial resolutions and qualities such as a high-definition (HD) level, a standard definition (SD) level, an H.264 level, and the like, and various frame-rates, thereby receiving a bit stream in a receiving terminal, and restoring and playing the bit stream so as to provide an optimal service to a terminal in various network environments and having various characteristics.

According to an aspect of the present invention, there is provided a streaming service system using an SVC server, the streaming service system including a receiving module to receive a video stream from the SVC server, a conversion module to convert the received video stream into a real-time video stream, and a streaming server to provide a streaming service using the converted real-time video stream.

According to another aspect of the present invention, there is provided a playback device using an SVC server, the playback device including a receiving module to receive a real-time video stream from a streaming server that operates in conjunction with the SVC server through a wireless fidelity (Wi-Fi) network, and a playing module to demodulate and play a video stream included in the real-time video stream.

According to still another aspect of the present invention, there is provided a streaming service method using an SVC server, the streaming service method including receiving a video stream from the SVC server, converting the received video stream into a real-time video stream, and providing a streaming service using the converted real-time video stream.

According to yet another aspect of the present invention, there is provided a device playback method using an SVC server, the method including receiving a real-time video stream including a video stream from a streaming server that operates in conjunction with the SVC server through a Wi-Fi network, and demodulating and playing the video stream included in the real-time video stream.

According to an embodiment of the present invention, it is possible to provide a single video content by constructing a single bit stream to have various spatial resolutions and qualities such as an HD level, an SD level, an H.264 level, and the like, and various frame-rates, thereby receiving a bit stream in a receiving terminal, and restoring and playing the bit stream, and it is possible to play a video by a stream using an SVC technology so as to provide an optimal service in various network environments and terminals having various specifications.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a streaming service system using a scalable video coding (SVC) server according to embodiments of the present invention;

FIG. 2 is a diagram illustrating a playback device using an SVC server according to embodiments of the present invention;

FIG. 3 is a flowchart illustrating an operational flow of a streaming service method using an SVC server according to embodiments of the present invention; and

FIG. 4 is a flowchart illustrating a device playback method using an SVC server according to embodiments of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Embodiments of the present invention may provide a 3-screen or n-screen service using a scalable video coding (SVC) technology that supports a one-person multi-device service in a Microsoft operating system of a mobile terminal. For example, a system configuration for providing a streaming service to the mobile operating system terminal is described below.

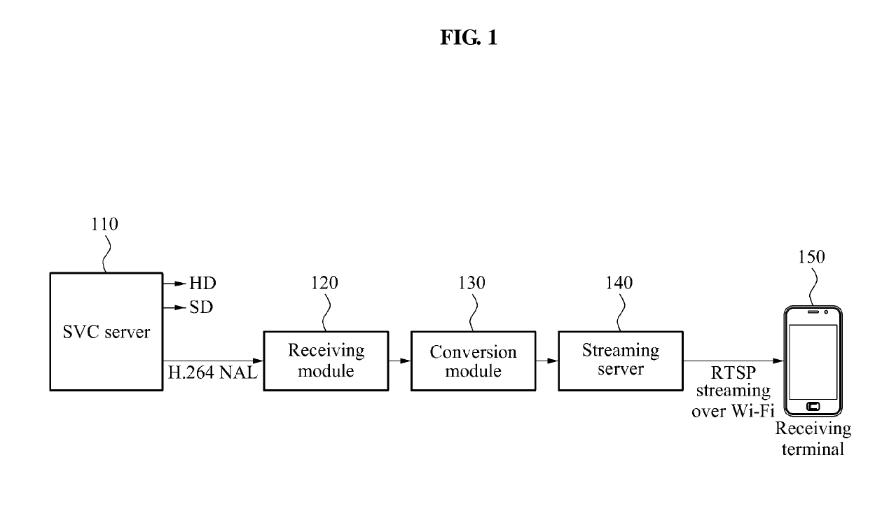

FIG. 1 is a diagram illustrating a streaming service system using an SVC server according to embodiments of the present invention.

Referring to FIG. 1, a streaming service system according to embodiments of the present invention may include a receiving module 120, a conversion module 130, and a streaming server 140. Components included in the streaming service system are described below.

An SVC server 110 may output an enhancement layer bit stream of a high-definition (HD) level and a standard definition (SD) level, and an H.264 network abstraction layer (NAL) stream corresponding to one of video streams.

The streaming service system may receive, from the SVC server 110, the H.264 NAL stream excluding the enhancement layer bit stream, convert the received H.264 NAL stream into a real-time streaming protocol (RTSP) stream corresponding to one of real-time video streams, and provide a streaming service using the converted RTSP stream to a receiving terminal 150.

The receiving module 120 that receives a stream in the streaming service system may receive, from the SVC server 110, the H.264 NAL stream corresponding to one of video streams, and deliver the H.264 NAL stream to the conversion module 130.

The conversion module 130 may convert the received H.264 NAL stream into the RTSP stream corresponding to one of real-time video streams. An operation of performing a stream conversion by the conversion module 130 is described below.

The conversion module 130 may extract, from the H.264 NAL stream, at least one piece of information between a previous reference (P) picture and an instantaneous decoding refresh (IDR) picture, generate a start code, that is a sequence parameter set (SPS), and a picture parameter set (PPS), using the at least one piece of extracted information, insert the start code into the H.264 NAL to construct the RTSP stream, and provide the constructed RTSP stream to the streaming server 140. Here, the IDR picture may correspond to a head picture of an image sequence, the SPS may correspond to information associated with modulation of an overall sequence such as a profile, a level, and the like, and the PPS may correspond to an encoding code of an overall picture.

The streaming server 140 may provide the receiving terminal 150 with a streaming service using the RTSP stream. An operation of the streaming server 140 will be further described.

In response to the RTSP stream being determined to correspond to the H.264 NAL stream by retrieving the start code from the RTSP stream, the streaming server 140 may provide the receiving terminal 150 with the streaming service using the RTSP stream.

The receiving terminal 150 may receive the RTSP stream from the streaming server 140, and demodulate and play the H.264 NAL stream included in the RTSP stream.

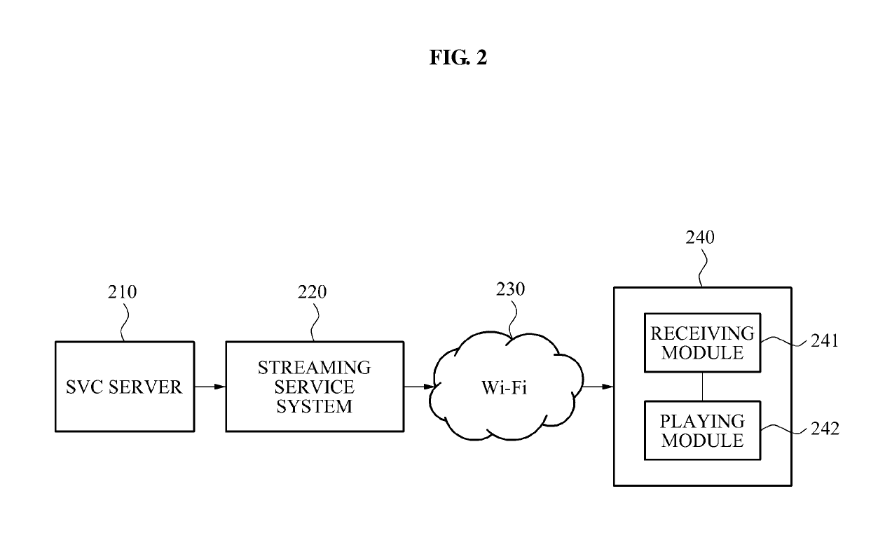

FIG. 2 is a diagram illustrating a playback device using an SVC server according to embodiments of the present invention.

Referring to FIG. 2, a playback device 240 according to embodiments of the present invention may include a receiving module 241 and a playing module 242. Components of the playback device 240 are described below.

In response to receiving a request for a streaming service from the playback device 240, a streaming service system 220 may inform an SVC server 210 about the request, receive, from the SVC server 210, an H.264 NAL stream corresponding to one of video streams, convert the received H.264 NAL stream into an RTSP stream corresponding to one of real-time video streams, and transmit the RTSP stream to the playback device 240. A streaming server included in the streaming service system 220 may transmit the RTSP stream to the playback device 240 through a wireless fidelity (Wi-Fi) network 230.

The receiving module 241 that receives a stream in the playback device 240 may receive the RTSP stream including the H.264 NAL stream corresponding to one of video streams from a streaming server that operates in conjunction with the SVC server 210 through the Wi-Fi network 230. The receiving module 241 may deliver the received RTSP stream to the playing module 242.

The playing module 242 may demodulate and play the H.264 NAL stream included in the RTSP stream corresponding to one of real-time video streams.

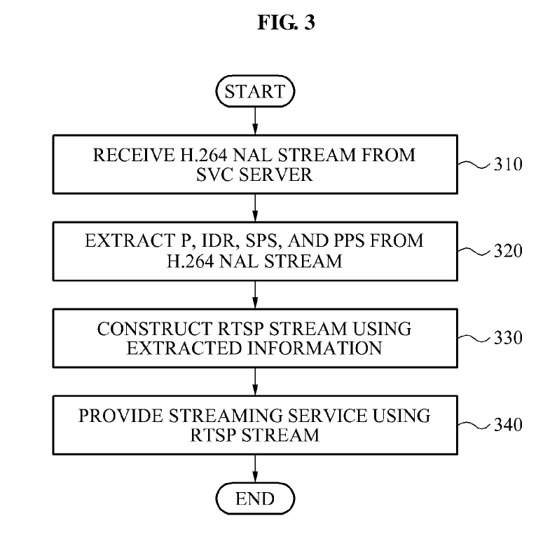

FIG. 3 is a flowchart illustrating an operational flow of a streaming service method using an SVC server according to embodiments of the present invention.

A streaming service method according to embodiments of the present invention may be embodied by the streaming service system illustrated in FIG. 1. Hereinafter, FIG. 3 will be described with reference to FIG. 1 to aid in the understanding of the present invention.

An SVC server may output an enhancement layer bit stream of an HD level and an SD level, and an H.264 NAL stream corresponding to one of video streams to provide an optimal video streaming service to a terminal in various network environments and having various specifications.

The streaming service system may receive, from the SVC server, the H.264 NAL stream excluding the enhancement layer bit stream, convert the received H.264 NAL stream into an RTSP stream corresponding to one of real-time video streams, and provide a streaming service using the converted RTSP stream to a receiving terminal. An operation of the streaming service system will be further described.

In operation 310, the streaming service system may control a receiving module that receives a stream, from the SVC server, in order to receive the H.264 NAL stream corresponding to one of video streams, and deliver the H.264 NAL stream to a conversion module.

The streaming service system may control the conversion module to convert the received H.264 NAL stream into the RTSP stream corresponding to one of real-time video streams. An operation of performing a stream conversion by the streaming service system is described below.

In operation 320, the streaming service system may extract, from the H.264 NAL stream, at least one piece of information between a P picture and an IDR picture.

In operation 330, the streaming service system may generate a start code, that is an SPS, and a PPS, using the at least one piece of extracted information, insert the start code into the H.264 NAL stream to construct the RTSP stream, and provide the constructed RTSP stream to a streaming server.

In operation 340, the streaming service system may control the streaming server to provide the receiving terminal with a streaming service using the RTSP stream. An operation of providing the streaming service by the streaming service system will be described.

The streaming service system may control the streaming server to retrieve a start code from the RTSP stream, and provide the receiving terminal with the streaming service using the RTSP stream in response to the RTSP stream being determined to correspond to the H.264 NAL stream.

The receiving terminal may receive the RTSP stream from the streaming server, and demodulate and play the H.264 NAL stream included in the RTSP stream. The receiving terminal may demodulate the H.264 NAL stream to play multimedia content.

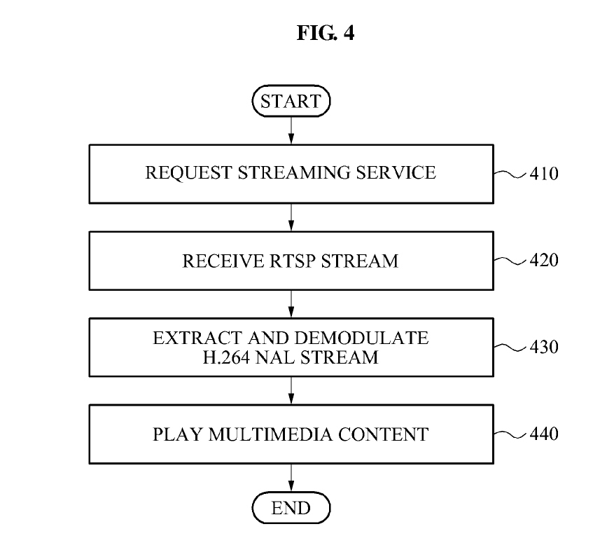

FIG. 4 is a flowchart illustrating a device playback method using an SVC server according to embodiments of the present invention.

A device playback method according to embodiments of the present invention may be embodied by the streaming service system illustrated in FIG. 2. Hereinafter, FIG. 4 will be described with reference to FIG. 2 to aid in the understanding of the present invention.

In operation 410, in response to receiving a request for a streaming service from a playback device, the streaming service system may inform an SVC server about the request, receive, from the SVC server, an H.264 NAL stream corresponding to one of video streams, convert the received H.264 NAL stream into an RTSP stream corresponding to one of real-time video streams, and transmit the RTSP stream to the playback device. A streaming server included in the streaming service system may transmit the RTSP stream to the playback device through a Wi-Fi network.

In operation 420, the playback device may control a receiving module that receives a stream to receive the RTSP stream including the H.264 NAL stream corresponding to one of video streams from the streaming server that operates in conjunction with the SVC server through the Wi-Fi network. The playback device may deliver the received RTSP stream to a playing module.

In operation 430, the playback device may control the playing module to demodulate and play the H.264 NAL stream included in the RTSP stream corresponding to one of real-time video streams. In operation 440, the playback device may demodulate the H.264 NAL stream to play multimedia content.

The above-described exemplary embodiments of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A streaming service system using a scalable video coding (SVC) server, the streaming service system comprising:
a receiving module to receive a video stream from the SVC server;
a conversion module to convert the received video stream into a real-time video stream; and
a streaming server to provide a streaming service using the converted real-time video stream.

2. The streaming service system of claim 1, wherein the video stream corresponds to an H.264 network abstraction layer (NAL) stream, and the real-time video stream corresponds to a real-time streaming protocol (RTSP) stream.

3. The streaming service system of claim 2, wherein the conversion module extracts, from the H.264 NAL stream, at least one piece of information between a previous reference (P) picture and an instantaneous decoding refresh (IDR) picture, and generates a start code, that is a sequence parameter set (SPS), and a picture parameter set (PPS), using the at least one piece of extracted information.

4. The streaming service system of claim 3, wherein the conversion module inserts the start code, into the H.264 NAL stream.

5. The streaming service system of claim 3, wherein, in response to the start code being retrieved from the RTSP stream, the streaming server determines the RTSP stream to be the H.264 NAL stream, and provide the streaming service.

6. A playback device using a scalable video coding (SVC) server, the playback device comprising:
a receiving module to receive a real-time video stream from a streaming server that operates in conjunction with the SVC server through a wireless fidelity (Wi-Fi) network; and
a playing module to demodulate and play a video stream included in the real-time video stream.

7. The playback device of claim 6, wherein the real-time video stream corresponds to a real-time streaming protocol (RTSP) stream, and the video stream corresponds to an H.264 network abstraction layer (NAL) stream.

8. A streaming service method using a scalable video coding (SVC) server, the streaming service method comprising:
receiving a video stream from the SVC server;
converting the received video stream into a real-time video stream; and
providing a streaming service using the converted real-time video stream.

9. The streaming service method of claim 8, wherein the video stream corresponds to an H.264 network abstraction layer (NAL) stream, and the real-time video stream corresponds to a real-time streaming protocol (RTSP) stream.

10. The streaming service method of claim 9, wherein the converting comprises:
extracting, from the H.264 NAL stream, at least one piece of information between a previous reference (P) picture and an instantaneous decoding refresh (IDR) picture; and
generating a start code, that is a sequence parameter set (SPS), and a picture parameter set (PPS), using the at least one piece of extracted information.

11. The streaming service method of claim 10, the converting further comprises:
inserting the start code into the H.264 NAL stream.

12. The streaming service method of claim 10, wherein the providing comprises:
determining whether the RTSP stream corresponds to the H.264 NAL stream by retrieving the start code from the RTSP stream; and
providing the streaming service using the RTSP stream in response to the RTSP stream being determined to correspond to the H.264 NAL stream.

13. A device playback method using a scalable video coding (SVC) server, the method comprising:
receiving a real-time video stream including a video stream from a streaming server that operates in conjunction with the SVC server through a wireless fidelity (Wi-Fi) network; and
demodulating and playing the video stream included in the real-time video stream.

14. The device playback method of claim 13, wherein the real-time video stream corresponds to a real-time streaming protocol (RTSP) stream, and the video stream corresponds to an H.264 network abstraction layer (NAL) stream.
